(19) United States
(12) Patent Application Publication
(10) Pub. No.: US 2024/0166112 A1
(43) Pub. Date: May 23, 2024

(54) HIGH-PRACTICABILITY CAR TRASH CAN

(71) Applicant: Shenzhen zhongdaxin Epoxy plate Co. Ltd., Shenzhen (CN)

(72) Inventor: Shengwen Huang, Shenzhen (CN)

(21) Appl. No.: 18/430,684

(22) Filed: Feb. 2, 2024

(30) Foreign Application Priority Data
Jan. 15, 2024 (CN) 202410054856.0

(51) Int. Cl. B60N 3/08; B65F 1/02; B65F 1/14; B65F 1/16

(52) U.S. Cl. CPC B60N 3/08; B65F 1/02; B65F 1/141; B65F 1/1646; B65F 2001/1676; B65F 2210/167; B65F 2210/18

(57) ABSTRACT

The present disclosure provides a high-practicability car trash can, including a trash can body and an anti-odor cover body connected to an upper part of the trash can body in a matched manner; the trash can body is of a storable can body structure made of an elastic soft material; the high-practicability car trash can further includes an anti-odor base arranged at a portion between the trash can body and the anti-odor cover body; a lower part of the anti-odor base and the upper part of the trash can body are matched in appearance; an upper part of the anti-odor base and the anti-odor cover body are matched in shape; the high-practicability car trash can further includes a rotatable connection rod configured to connect the anti-odor cover body to the anti-odor base; and one end of the rotatable connection rod is rotatably movably connected to the anti-odor cover body.

### TECHNICAL FIELD

The present disclosure relates to the technical field of car trash can products, and in particular, to a high-practicability car trash can with a reasonable structural design, application convenience, and high sealing property.

### BACKGROUND

With the continuous development of the society, there are more and more sedan cars. It is inevitable to produce garbage when people sit in sedan cars. Throwing garbage out of windows is unethical. Most car owners will choose to place a trash can in the cars. Moreover, a space in the car is closed. As most of containers for collecting waste food in the closed space are open containers, there are problems of odor and liquid leakage. In addition, there are problems of food waste and overflowing of residual liquid in the closed space, which can easily lead to inevitable moisture and mildewing, affecting the use of the car.

Based on this, various types of garbage bags with certain sealing effects and trash cans with certain sealing effects have emerged on the market. In practical applications, due to a small space inside the car, it is not possible to place a large-sized trash can. The car is generally in a closed state. If the sealing performance of the trash can is poor, strong odor will be given off, which will affect the riding experience. To solve the above problems, in the prior art, a plastic fiber made of cloth and an aluminum film, plastic, or a container stuck with a layer of self-adhesive aluminum foil or a rubber film is generally used to collect waste food or items. However, the items stored will still be affected by moisture and mold. Over time, the problems such as overflowing of residual liquid and odor inevitably occur. The space in the car will be inevitably moisturized and molded, which affects the use of the car. Car equipment will also be moisturized and molded, and even the equipment will be damaged. When waste food is removed from a non-waterproof container, liquid will leak, or the rubber film needs to be taken out for cleaning. Furthermore, it is hard to clean the container, and cleaning the container wastes time and labor. The product in the prior has a series of the above problems. This affects practical applications and popularizations of the product.

The utility model patent No. CN202021034163.9, entitled Car Trash Can, specifically discloses a car trash can, which includes an upper trash can body, a lower trash can body, and a trash can hook. The trash can hook is connected to the upper trash can body through a connecting rod; a strip-shaped groove is arranged on a back surface of the upper trash can body; a strip-shaped convex block is arranged at a top of the trash can hook; the strip-shaped convex block fixes the trash can hook in the strip-shaped groove of the upper trash can body; the upper trash can body and the lower trash can body are connected in a buckling manner; the lower trash can body is provided with a horizontal sieve; the horizontal sieve and the lower trash can body are of an integrated structure; a movable inner drum is arranged inside the lower trash can body; and the movable inner drum can be pulled out from one side of the lower trash can body. The present disclosure has a reasonable structural design, occupies a small space, and can solve the problem of garbage classification in the car trash can.

A product corresponding to the technical features disclosed in the above-mentioned patent has the problems of large size, low sealing performance, and the like. Based on this, further structural improvement needs to be made.

### SUMMARY

Problems to be solved in the prior art by the present disclosure are as follows:

As a space in a car is narrow, a large-sized trash can cannot be placed. Furthermore, the car is generally in a closed state. If the sealing performance of the trash can is poor, strong odor will be given off, which will affect the riding experience. The product in the prior has the problems of poor storage, poor sealing performance, and the like.

Solutions of the present disclosure for solving the technical problems are as follows:

A high-practicability car trash can is provided, including a trash can body and an anti-odor cover body connected to an upper part of the trash can body in a matched manner, wherein

the trash can body is of a storable can body structure made of an elastic soft material;

the high-practicability car trash can further comprises an anti-odor base arranged at a portion between the trash can body and the anti-odor cover body; a lower part of the anti-odor base and the upper part of the trash can body are matched in appearance; an upper part of the anti-odor base and the anti-odor cover body are matched in shape;

the high-practicability car trash can further comprises a rotatable connection rod component configured to connect the anti-odor cover body to the anti-odor base; one end of the rotatable connection rod component is rotatably movably connected to the anti-odor cover body, and the other end is rotatably movably connected to the anti-odor base, thus opening and closing the anti-odor cover body;

the high-practicability car trash can further comprises a container fixing ring arranged at the upper part of the trash can body; a can body sealing part is arranged at a top of the trash can body in a surrounding manner; a fixing ring sealing part that is abutted with the can body sealing part in a matched manner and achieves a hermetical connection effect is arranged around a periphery of the container fixing ring in an integrally molded manner; and

the high-practicability car trash can further comprises a sling connected to an outer side of the trash can body and configured to fix the trash can body to an external object.

Preferably, a rotating shaft limiting ring is further arranged on an inner side of the upper part of the trash can body;

a limiting ring slot body configured to embed the rotating shaft limiting ring is formed in the inner side of the upper part of the trash can body; the limiting ring slot body is matched with the rotating shaft limiting ring in shape; and

the rotating shaft limiting ring is located at a portion between the upper part of the trash can body and the container fixing ring.

Preferably, through holes are respectively formed in two sides of the upper part of the trash can body;

rotating shaft rods penetrating through the through holes are respectively arranged on two sides of the rotating shaft limiting ring; and

the sling is movably connected to the rotating shaft rods.

Preferably, a can body limiting part configured to mount the rotating shaft limiting ring and the container fixing ring is arranged at upper part of the trash can body; and

an outer diameter of the can body limiting part is greater than an outer diameter size of a lower part of the trash can body to form the limiting ring slot body.

Preferably, a periphery of the upper part of the trash can body protrudes outwards to form the can body sealing part; the fixing ring sealing part is of a barb type structure;

when the container fixing ring is connected to the trash can body, the fixing ring sealing part is buckled on an outer side of the can body sealing part to achieve hermetical connection; and

an outer edge of the lower part of the anti-odor base overlays an upper side of the fixing ring sealing part.

Preferably, a cover body connection part movably connected to one end of the rotatable connection rod component is arranged on a back surface of the anti-odor cover body in an integrally molded manner;

the rotatable connection rod component comprises a rotatable connection rod;

a base supporting rod is arranged on an inner side of the anti-odor base in an integrally molded manner; the other end of the rotatable connection rod relative to the cover body connection part is movably connected to the base supporting rod to achieve spinning;

the high-practicability car trash can further comprises a tension spring configured to maintain an elastic recovery property of the rotatable connection rod; and

one end of the tension spring is connected to an end portion of the rotatable connection rod, and the other end is connected to the base supporting rod.

Preferably, the base supporting rod extends downwards and is provided with a supporting rod extension part;

the rotatable connection rod is provided with a connection rod rotating shaft at the position of the supporting rod extension part; the connection rod rotating shaft is movably connected to the supporting rod extension part; and

the rotatable connection rod is provided, at one end of the tension spring, with a tension spring connection part rotatably movably connected to the tension spring.

Preferably, the cover body connection part includes a first cover body connection side plate and a second cover body connection side plate which are opposite to each other;

the first cover body connection side plate and the second cover body connection side plate are respectively provided with arc-shaped slot bodies or circular through holes;

the rotatable connection rod is provided with a cover body connection rotating shaft at one end of the cover body connection part; the cover body connection rotating shaft is connected to the arc-shaped slot bodies or the circular through holes in a matched manner;

the cover body connection part is located at a portion, close to an edge, on an outer side of the anti-odor cover body; and

there are two rotatable connection rods and two cover body connection parts, which are symmetrically arranged on the left and right.

Preferably, the sling includes a first sling connected to the rotating shaft rods and a second sling connected to the lower part of the trash can body;

a can body sling connection part connected to the second sling in a matched manner is arranged on the lower part of the trash can body; and

an end portion of the second sling is connected to a hook configured to hook an object at a lower part of a seat.

Preferably, an upper part of the anti-odor cover body is further provided with a lifting lug to open the anti-odor cover body.

Technical effects achieved by solving the technical problems by the present disclosure are as follows:

Compared with the prior art, the high-practicability car trash can of the present disclosure provides a high-practicability car trash can is simultaneously provided with a trash can body 11 and an anti-odor cover body 13 connected to an upper part of the trash can body 11 in a matched manner; the trash can body 11 is of a storable can body structure made of an elastic soft material; the high-practicability car trash can further includes an anti-odor base 15 arranged at a portion between the trash can body 11 and the anti-odor cover body 13; a lower part of the anti-odor base 15 and the upper part of the trash can body 11 are matched in appearance; an upper part of the anti-odor base 15 and the anti-odor cover body 13 are matched in shape; the high-practicability car trash can further includes a rotatable connection rod component 16 configured to connect the anti-odor cover body 13 to the anti-odor base 15; and one end of the rotatable connection rod component 16 is rotatably movably connected to the anti-odor cover body 13, and the other end is rotatably movably connected to the anti-odor base 15, thus opening and closing the anti-odor cover body 13. The high-practicability car trash can further includes a container fixing ring 17 arranged at the upper part of the trash can body 11; a can body sealing part 115 is arranged at a top of the trash can body 11 in a surrounding manner; a fixing ring sealing part 171 that is abutted with the can body sealing part 115 in a matched manner and achieves a hermetical connection effect is arranged around a periphery of the container fixing ring 17 in an integrally molded manner; and the high-practicability car trash can further includes a sling connected to an outer side of the trash can body 11 and configured to fix the trash can body 11 to an external object. In a practical application process, hermetical connection between the can body sealing part 115 and a fixing ring sealing part 171 can be better used to achieve high sealing performance of the trash can, so as to prevent the influence of odor diffusion on the use experience.

### BRIEF DESCRIPTION OF THE DRAWINGS

FIG. 1 is a schematic structural diagram of a three-dimensional state of a high-practicability car trash can according to the present disclosure.

FIG. 2 is a schematic structural diagram of an exploded state of a high-practicability car trash can according to the present disclosure.

FIG. 3 is a schematic structural diagram of a cross-sectional state of a high-practicability car trash can according to the present disclosure.

FIG. 4 is a schematic structural diagram of a three-dimensional state of an anti-odor cover body in a high-practicability car trash can according to the present disclosure.

FIG. 5 is a schematic structural diagram of a three-dimensional state of an anti-odor base in a high-practicability car trash can according to the present disclosure.

FIG. 6 is a schematic structural diagram of two open states of a high-practicability car trash can according to the present disclosure.

FIG. 7 is a schematic structural diagram of a car application state of a high-practicability car trash can according to the present disclosure.

### IN THE DRAWINGS

11: trash can body; 111: can body sling connection part; 112: can body limiting part; 113: limiting ring slot body; 114: through hole; 115: can body sealing part; 12: second sling; 13: anti-odor cover body; 131: cover body connecting part; 1311: first cover body connection side plate; 1312: second cover body connection side plate; 1313: arc-shaped slot body or circular through hole; 15: anti-odor base; 151: base supporting rod; 152: supporting rod extension part; 16: rotatable connection rod component; 161: rotatable connection rod; 162: cover body connection rotating shaft; 163: connection rod rotating shaft; 164: tension spring connection part; 165: tension spring; 17: container fixing ring; 171: fixing ring sealing part; 18: rotating shaft limiting ring; 181: first sling; and 182: rotating shaft rod.

### DETAILED DESCRIPTION OF THE EMBODIMENTS

In order to make the objectives, technical solutions, and advantages of the present disclosure clearer, the following is a further detailed explanation of the present disclosure in conjunction with the accompanying drawings and embodiments. It should be understood that the specific embodiments described here are only intended to explain the present disclosure and are not intended to limit this invention.

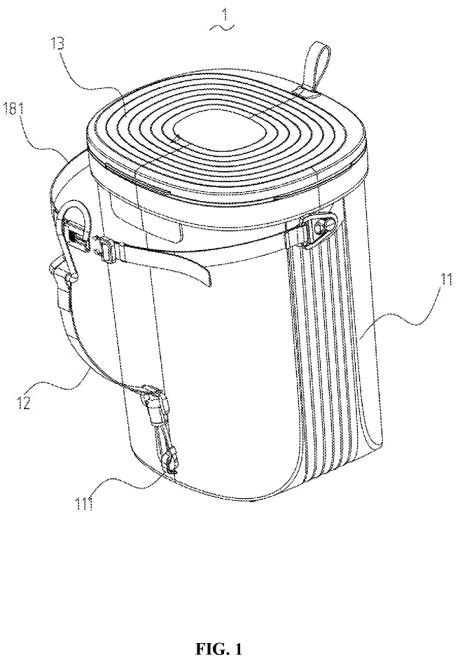

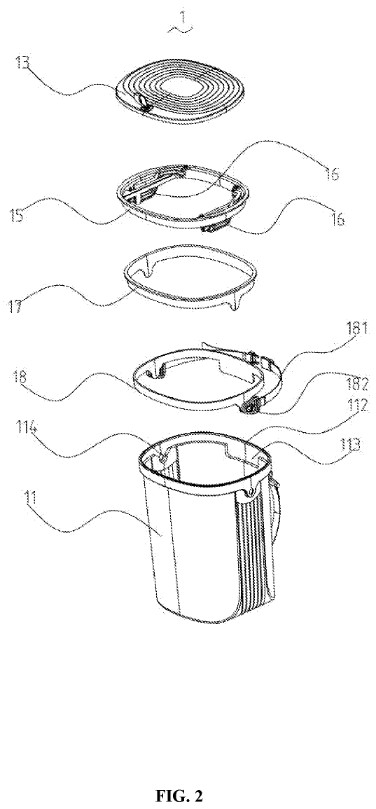

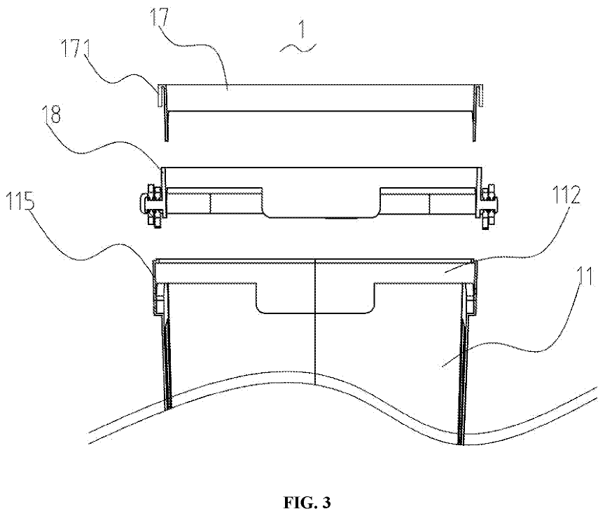

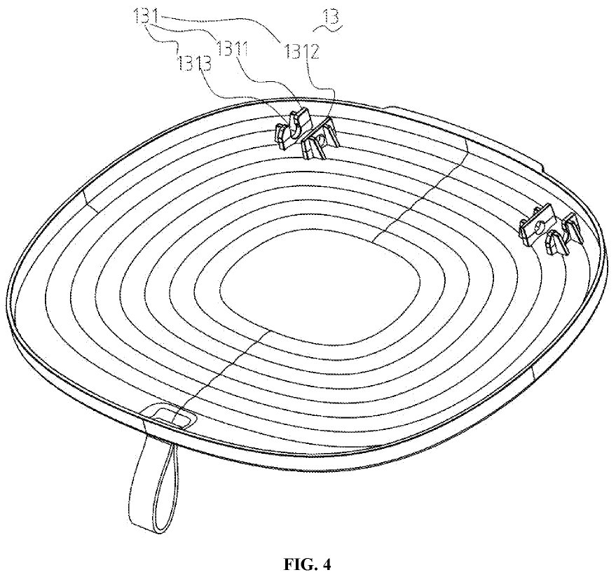

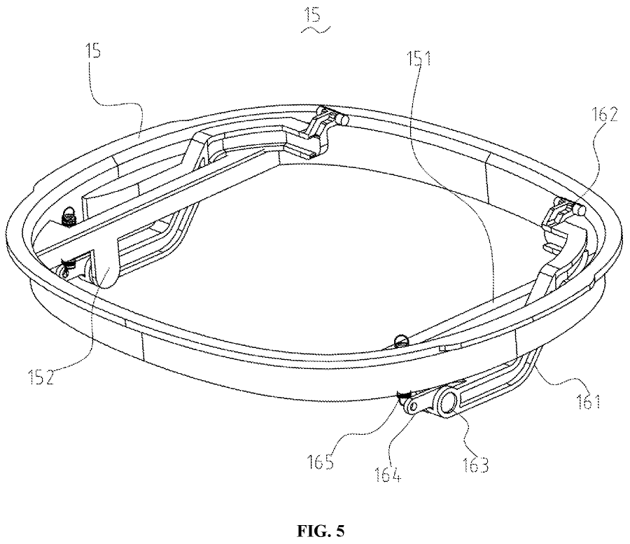

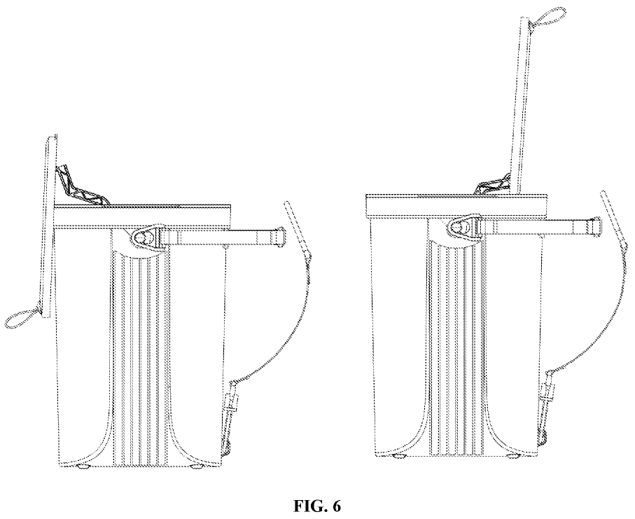

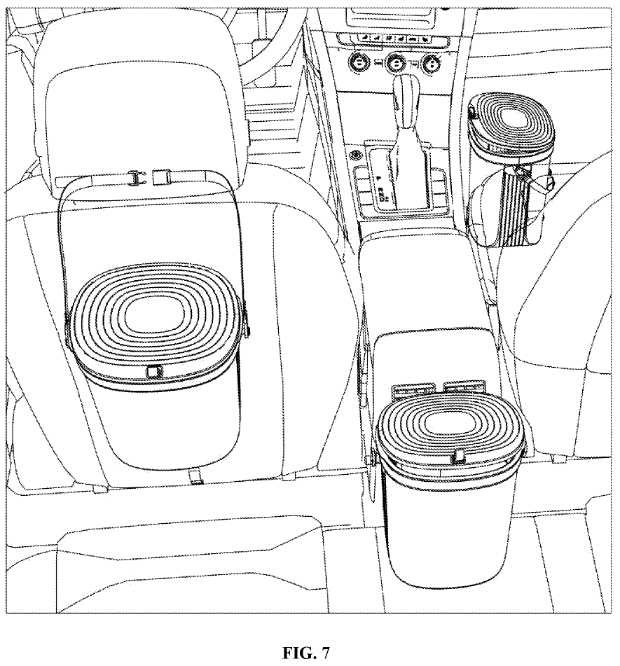

Referring to FIG. 1 to FIG. 7, the present disclosure discloses a high-practicability car trash can 1, including a trash can body 11 and an anti-odor cover body 13 connected to an upper part of the trash can body 11 in a matched manner.

The anti-odor cover body 13 can be folded forwards to be parallel or folded forwards into an L-shaped open state.

The trash can body 11 is of a storable can body structure made of an elastic soft material. In a non-use state, the trash can body 11 is compressed to be stored, which saves a storage space.

In an actual design, the hardness of the upper part of the trash can body 11 can be greater than the hardness of a can main body itself, achieving a better storage action.

The above-mentioned elastic soft material can be silica gel or a thermoplastic elastomer material. A main elastic material has Shore hardness of about 40 degrees to about 80 degrees.

The thermoplastic material can be a workpiece made of a thermoplastic material such as PE, PP, nylon, and ABS, and is stably combined through fusion. In order to achieve a better usage effect, the trash can body 11 in the practical application can also be a composite material.

The high-practicability car trash can further includes an anti-odor base 15 arranged at a portion between the trash can body 11 and the anti-odor cover body 13; a lower part of the anti-odor base 15 and the upper part of the trash can body 11 are matched in appearance; an upper part of the anti-odor base 15 and the anti-odor cover body 13 are matched in shape.

The entire anti-odor base 15 is of an annular structure, which corresponds to the structure of the upper part of the trash can body 11.

The high-practicability car trash can further includes a rotatable connection rod component 16 configured to connect the anti-odor cover body 13 to the anti-odor base 15; one end of the rotatable connection rod component 16 is rotatably movably connected to the anti-odor cover body 13, and the other end is rotatably movably connected to the anti-odor base 15, thus opening and closing the anti-odor cover body 13.

The high-practicability car trash can further includes a container fixing ring 17 arranged at the upper part of the trash can body 11; a can body sealing part 115 is arranged at a top of the trash can body 11 in a surrounding manner; and a fixing ring sealing part 171 that is abutted with the can body sealing part 115 in a matched manner and achieves a hermetical connection effect is arranged around a periphery of the container fixing ring 17 in an integrally molded manner.

In specific applications, the fixing ring sealing part 171 is mainly of a sealing structure abutted with the container fixing ring 17 in a matched manner, which can be in coverage type sealed contact, or of a snap-in structure, or the like.

The high-practicability car trash can further includes a sling connected to an outer side of the trash can body 11 and configured to fix the trash can body 11 to an external object.

The present disclosure is simultaneously provided with a trash can body 11 and an anti-odor cover body 13 connected to an upper part of the trash can body 11 in a matched manner; the trash can body 11 is of a storable can body structure made of an elastic soft material; the high-practicability car trash can further includes an anti-odor base 15 arranged at a portion between the trash can body 11 and the anti-odor cover body; a lower part of the anti-odor base 15 and the upper part of the trash can body 11 are matched in appearance; an upper part of the anti-odor base 15 and the anti-odor cover body 13 are matched in shape; the high-practicability car trash can further includes a rotatable connection rod component 16 configured to connect the anti-odor cover body 13 to the anti-odor base 15; and one end of the rotatable connection rod component 16 is rotatably movably connected to the anti-odor cover body 13, and the other end is rotatably movably connected to the anti-odor base 15, thus opening and closing the anti-odor cover body 13. The high-practicability car trash can further includes a container fixing ring 17 arranged at the upper part of the trash can body 11; a can body sealing part 115 is arranged at a top of the trash can body 11 in a surrounding manner; a fixing ring sealing part 171 that is abutted with the can body sealing part 115 in a matched manner and achieves a hermetical connection effect is arranged around a periphery of the container fixing ring 17 in an integrally molded manner; and the high-practicability car trash can further includes a sling connected to an outer side of the trash can body 11 and configured to fix the trash can body 11 to an external object. In a practical application process, hermetical connection between the can body sealing part 115 and a fixing ring sealing part 171 can be better used to achieve high sealing performance of the trash can, so as to prevent the influence of odor diffusion on the use experience.

In a specific application process, the anti-leakage and anti-odor structure of the car trash can of the present disclosure has a function of preventing water leakage and odor, which can achieve good water leakage and odor prevention effect, so as to significantly improve the problems that the traditional car trash can is not waterproof, is not anti-odor, and is not easy to clean.

In some other embodiments, a rotating shaft limiting ring 18 is further arranged on an inner side of the upper part of the trash can body 11.

A limiting ring slot body 113 configured to embed the rotating shaft limiting ring 18 is formed in the inner side of the upper part of the trash can body 11; and the limiting ring slot body 113 is matched with the rotating shaft limiting ring 18 in shape.

The rotating shaft limiting ring 18 is located at a portion between the upper part of the trash can body 11 and the container fixing ring 17.

Through holes 114 are respectively formed in two sides of the upper part of the trash can body 11.

Rotating shaft rods 182 penetrating through the through holes 114 are respectively arranged on two sides of the rotating shaft limiting ring 18.

The sling is movably connected to the rotating shaft rods 182, so that an angle of the sling can be adjusted according to an actual usage condition.

In practical applications, the container fixing ring 17, the rotating shaft limiting ring 18, and the upper part of the trash can body 11 can be made into a hot-molten integrated structure. To achieve a better sealing effect, it is also possible to reduce the quantity of scattered components after actual manufacturing is completed. Hot-molten integrated or dispersed structural constitutions all fall within the protection scope of the present disclosure and are equivalent technical solutions.

A can body limiting part 112 configured to mount the rotating shaft limiting ring 18 and the container fixing ring 17 is arranged at upper part of the trash can body 11.

An outer diameter of the can body limiting part 112 is greater than an outer diameter size of a lower part of the trash can body 11 to form the limiting ring slot body 113.

A periphery of the upper part of the trash can body 11 protrudes outwards to form the can body sealing part 115; and the fixing ring sealing part 171 is of a barb type structure.

When the container fixing ring 17 is connected to the trash can body 11, the fixing ring sealing part 171 is buckled on or covered, in a matched manner, at an outer side of the can body sealing part 115 to achieve hermetical connection.

An outer edge of the lower part of the anti-odor base 15 overlays an upper side of the fixing ring sealing part 172.

In an actual design, structures similar to the above-mentioned sealing structure can also be considered as equivalent technical solutions, such as a sealing slot and a sealing protrusion.

The present disclosure does not specifically limit a length size of the can body sealing part 115.

A cover body connection part 131 movably connected to one end of the rotatable connection rod component 15 is arranged on a back surface of the anti-odor cover body 13 in an integrally molded manner.

The rotatable connection rod component 16 includes a rotatable connection rod 161.

A base supporting rod 151 is arranged on an inner side of the anti-odor base 15 in an integrally molded manner; the other end of the rotatable connection rod 161 relative to the cover body connection part 131 is movably connected to the base supporting rod 151 to achieve spinning.

The high-practicability car trash can further includes a tension spring 165 configured to maintain an elastic recovery property of the rotatable connection rod 161.

The rotatable connection rod 161 is provided with a structure of a cover body connection rotating shaft 162 at one end of the cover body connection part 131.

One end of the tension spring 165 is connected to an end portion of the rotatable connection rod 161, and the other end is connected to the base supporting rod 151.

The base supporting rod 151 extends downwards and is provided with a supporting rod extension part 152.

The rotatable connection rod 161 is provided with a connection rod rotating shaft 163 at the position of the supporting rod extension part 152; and the connection rod rotating shaft 163 is movably connected to the supporting rod extension part 152.

The rotatable connection rod 161 is provided, at one end of the tension spring 165, with a tension spring connection part 164 rotatably movably connected to the tension spring 165.

The cover body connection part 131 includes a first cover body connection side plate 1311 and a second cover body connection side plate 1312 which are opposite to each other.

The first cover body connection side plate 1311 and the second cover body connection side plate 1312 are respectively provided with arc-shaped slot bodies or circular through holes 1313.

Or, one side is provided with the arc-shaped slot body, and the other side is provided with the circular through hole structure, which facilitates removal and separation of the rotatable connection rod 161 and the cover body connection part 131.

The rotatable connection rod 161 is provided with a cover body connection rotating shaft 162 at one end of the cover body connection part 131; the cover body connection rotating shaft 162 is connected to the arc-shaped slot bodies or the circular through holes 1313 in a matched manner.

The cover body connection part 131 is located at a portion, close to an edge, on an outer side of the anti-odor cover body 13.

There are two rotatable connection rods 161 and two cover body connection parts 131, which are symmetrically arranged on the left and right.

The sling includes a first sling 181 connected to the rotating shaft rods 182 and a second sling 12 connected to the lower part of the trash can body 11.

A can body sling connection part 111 connected to the second sling 12 in a matched manner is arranged on the lower part of the trash can body 11.

An end portion of the second sling 12 is connected to a hook configured to hook an object at a lower part of a seat.

An upper part of the anti-odor cover body 13 is further provided with a lifting lug to manually open the anti-odor cover body 13.

Technical effects achieved by solving the technical problems by the present disclosure are as follows:

Compared with the prior art, the high-practicability car trash can 1 of the present disclosure provides a high-practicability car trash can is simultaneously provided with a trash can body 11 and an anti-odor cover body 13 connected to an upper part of the trash can body 11 in a matched manner; the trash can body 11 is of a storable can body structure made of an elastic soft material; the high-practicability car trash can further includes an anti-odor base 15 arranged at a portion between the trash can body 11 and the anti-odor cover body 13; a lower part of the anti-odor base 15 and the upper part of the trash can body 11 are matched in appearance; an upper part of the anti-odor base 15 and the anti-odor cover body 13 are matched in shape; the high-practicability car trash can further includes a rotatable connection rod component 16 configured to connect the anti-odor cover body 13 to the anti-odor base 15; and one end of the rotatable connection rod component 16 is rotatably movably connected to the anti-odor cover body 13, and the other end is rotatably movably connected to the anti-odor base 15, thus opening and closing the anti-odor cover body 13. The high-practicability car trash can further includes a container fixing ring 17 arranged at the upper part of the trash can body 11; a can body sealing part 115 is arranged at a top of the trash can body 11 in a surrounding manner; a fixing ring sealing part 171 that is abutted with the can body sealing part 115 in a matched manner and achieves a hermetical connection effect is arranged around a periphery of the container fixing ring 17 in an integrally molded manner; and the high-practicability car trash can further includes a sling connected to an outer side of the trash can body 11 and configured to fix the trash can body 11 to an external object. In a practical application process, hermetical connection between the can body sealing part 115 and a fixing ring sealing part 171 can be better used to achieve high sealing performance of the trash can, so as to prevent the influence of odor diffusion on the use experience.

The above implementations of the present disclosure do not constitute a limitation on the protection scope of the present disclosure. Any modification, equivalent replacement, and improvement made within the spirit and principle of the present disclosure shall fall within the protection scope of the claims of the present disclosure.

What is claimed is:

1. A high-practicability car trash can, comprising a trash can body and an anti-odor cover body connected to an upper part of the trash can body in a matched manner, wherein the trash can body is of a storable can body structure made of an elastic soft material;
the high-practicability car trash can further comprises an anti-odor base arranged at a portion between the trash can body and the anti-odor cover body; a lower part of the anti-odor base and the upper part of the trash can body are matched in appearance; an upper part of the anti-odor base and the anti-odor cover body are matched in shape;
the high-practicability car trash can further comprises a rotatable connection rod component configured to connect the anti-odor cover body to the anti-odor base; one end of the rotatable connection rod component is rotatably movably connected to the anti-odor cover body, and the other end is rotatably movably connected to the anti-odor base, thus opening and closing the anti-odor cover body;
the high-practicability car trash can further comprises a container fixing ring arranged at the upper part of the trash can body; a can body sealing part is arranged at a top of the trash can body in a surrounding manner; a fixing ring sealing part that is abutted with the can body sealing part in a matched manner and achieves a hermetical connection effect is arranged around a periphery of the container fixing ring in an integrally molded manner; and
the high-practicability car trash can further comprises a sling connected to an outer side of the trash can body and configured to fix the trash can body to an external object.

2. The high-practicability car trash can according to claim 1, wherein a rotating shaft limiting ring is further arranged on an inner side of the upper part of the trash can body;
a limiting ring slot body configured to embed the rotating shaft limiting ring is formed in the inner side of the upper part of the trash can body; the limiting ring slot body is matched with the rotating shaft limiting ring in shape; and
the rotating shaft limiting ring is located at a portion between the upper part of the trash can body and the container fixing ring.

3. The high-practicability car trash can according to claim 1, wherein through holes are respectively formed in two sides of the upper part of the trash can body;
rotating shaft rods penetrating through the through holes are respectively arranged on two sides of the rotating shaft limiting ring; and
the sling is movably connected to the rotating shaft rods.

4. The high-practicability car trash can according to claim 2, wherein a can body limiting part configured to mount the rotating shaft limiting ring and the container fixing ring is arranged at upper part of the trash can body; and
an outer diameter of the can body limiting part is greater than an outer diameter size of a lower part of the trash can body to form the limiting ring slot body.

5. The high-practicability car trash can according to claim 1, wherein a periphery of the upper part of the trash can body protrudes outwards to form the can body sealing part; the fixing ring sealing part is of a barb type structure;
when the container fixing ring is connected to the trash can body, the fixing ring sealing part is buckled on an outer side of the can body sealing part to achieve hermetical connection; and
an outer edge of the lower part of the anti-odor base overlays an upper side of the fixing ring sealing part.

6. The high-practicability car trash can according to claim 1, wherein a cover body connection part movably connected to one end of the rotatable connection rod component is arranged on a back surface of the anti-odor cover body in an integrally molded manner;
the rotatable connection rod component comprises a rotatable connection rod;
a base supporting rod is arranged on an inner side of the anti-odor base in an integrally molded manner; the other end of the rotatable connection rod relative to the cover body connection part is movably connected to the base supporting rod to achieve spinning;
the high-practicability car trash can further comprises a tension spring configured to maintain an elastic recovery property of the rotatable connection rod; and
one end of the tension spring is connected to an end portion of the rotatable connection rod, and the other end is connected to the base supporting rod.

7. The high-practicability car trash can according to claim 6, wherein the base supporting rod extends downwards and is provided with a supporting rod extension part;
the rotatable connection rod is provided with a connection rod rotating shaft at the position of the supporting rod extension part; the connection rod rotating shaft is movably connected to the supporting rod extension part; and
the rotatable connection rod is provided, at one end of the tension spring, with a tension spring connection part rotatably movably connected to the tension spring.

8. The high-practicability car trash can according to claim 6, wherein the cover body connection part comprises a first cover body connection side plate and a second cover body connection side plate which are opposite to each other;
the first cover body connection side plate and the second cover body connection side plate are respectively provided with arc-shaped slot bodies or circular through holes;
the rotatable connection rod is provided with a cover body connection rotating shaft at one end of the cover body connection part; the cover body connection rotating shaft is connected to the arc-shaped slot bodies or the circular through holes in a matched manner;
the cover body connection part is located at a portion, close to an edge, on an outer side of the anti-odor cover body; and
there are two rotatable connection rods and two cover body connection parts, which are symmetrically arranged on the left and right.

9. The high-practicability car trash can according to claim 3, wherein the sling comprises a first sling connected to the rotating shaft rods and a second sling connected to the lower part of the trash can body;
a can body sling connection part connected to the second sling in a matched manner is arranged on the lower part of the trash can body; and
an end portion of the second sling is connected to a hook configured to hook an object at a lower part of a seat.

10. The high-practicability car trash can according to claim 1, wherein an upper part of the anti-odor cover body is further provided with a lifting lug to open the anti-odor cover body.
